(19) United States
(12) Patent Application Publication
(10) Pub. No.: US 2002/0005488 A1
(43) Pub. Date: Jan. 17, 2002

(54) X-RAY OR GAMMA PHOTON DETECTOR ARRANGEMENT WITH A FIBRE OPTIC TAPER WITH A CURVED INPUT SURFACE

(76) Inventor: JULES HENDRIX, HAMBURG (DE)

Correspondence Address: SCOTT W KELLEY, KELLY BAUERSFELD LOWRY & KELLEY, 6320 CANOGA AVENUE, SUITE 1650, WOODLAND HILLS, CA, 91367

(21) Appl. No.: 09/230,989

(22) PCT Filed: Aug. 5, 1997
(86) PCT No.: PCT/EP97/04243

(30) Foreign Application Priority Data
Aug. 5, 1996 (DE) 296 13 558.5

(51) Int. Cl. G01T 1/20

(52) U.S. Cl. 250/368

(57) ABSTRACT

In order to make available a detector assembly (100) for photons, more particularly X-ray gamma quanta, with a fiber glass body (10) possessing a screen surface (12) for the imaging of photons, a detector surface (14) with a photon detector (16) mounted thereupon as well as an intermediate section (18) which conducts photons imaged by the screen surface (12) to the detector surface (14); which permits the detection of as large as possible a solid angle in conjunction with a minimal distortion of the image, it is proposed that the screen surface (12) be configured in the form of a curved surface area.

### TECHNICAL AREA

The invention sets out from a detector assembly for photons, more particularly X-ray or gamma quanta, with a fiber glass body, which possesses a screen surface for the imaging of photons, a detector area with a photon detector disposed thereupon as well as an intermediate section which conducts photons imaged by the screen surface to the detector area.

### STATE OF THE ART

Detector assemblies with photon detector are employed e.g. in the imaging of X-ray diffraction patterns in the determination of monocrystal structures. Most recently, a CCD (charge-coupLed device) system is used. However, these CCD systems are subject to the problem that their imaging area is very small and, over and above this, that they are incapable of detecting X-rays direct within the interesting energy range.

That is why fiber glass bodies, so-called fiber optic tapers, are made use of which, on the one hand, image by means of a tapering body, the screen surface on the size of the CCD detector reduced in size and, on the other hand, by means of a layer of phosphorus on the screen surface, convert on the screen surface gamma quanta (X-radiation) into photons of a different wave-Length so as to enable the CCD detector to detect the same. With these fiber glass bodies it is possible by way of example to collect scattered radiation from an object to be analyzed and to image the same on the surface of the CCD detector.

The disadvantage involved in employing these known fiber glass bodies is that a spherical scattered radiation from e.g. a monocrystal to be analyzed, is imaged on the flat, plane area of the screen surface. On account of the projection this leads to distortions of the image. Imaged points are, by way of example, elongated ovals and the angular resolution decreases constantly more and more with increasing solid angles.

In addition, from a production-technical point of view, the expansion of such fiber glass bodies is limited. This restricts the possible detectable solid angle considerably. However, for almost all X-ray applications as large as possible a solid angle or a maximal screen surface is desired.

### EXPLANATION OF THE INVENTION, TECHNICAL PROBLEM, SOLUTION, ADVANTAGES

That is why the technical problem of the invention is to make available a detector assembly of the aforestated type, which permits the detection of as large a solid angle as possible with a minimal distortion of the image. A further technical problem consists in obtaining an as great as possible an expansion of the screen surface for a certain diameter of the fiber glass body.

This technical problem is resolved with a detector assembly of the type stated in the foregoing by means of the features characterized in the claim 1. According to the invention it is achieved hereby that, for a given diameter of the fiber glass body, the greatest possible expansion of the screen surface is achieved. It can preferably be achieved that a significantly larger screen surface and a more powerful reduction in size of this surface on the detector is obtained without having to accept the disadvantage of an excessive signal loss.

For this, according to the invention provision is made for the screen surface to be configured as a curved surface area, in which case a curvature is provided which is adapted to the application. The same is constructed in an advantageous manner so as to possess the configuration of a spherical shell, a cylindrical shell or that of a parabola. In this connection, for the crystal structure analysis, a spherical shell and for the powder diffratometry for RCBF and CT tomography, a cylindrical configuration is provided. The curvature makes possible a solid angle of 180° or more and a vertical incidence of the scattered radiation on the image-forming screen, so that no distortions occur in the image on the detector surface. It is furthermore possible to determine the distance between crystal and phosphorus in such a way that the separation or the reflections or the reduction of the reflection angle over the entire detector surface is maximal and almost constant.

In the especially preferred embodiment, in which the curved surface possesses the configuration of a spherical shell, it has been shown that the configuration of a spherical shell permits the detection of a largest possible solid angle. With the construction of the curved surface it is intended that—more particularly in the case of X-ray diffraction patterns—a minimal distortion of the image is obtained, to be more precise, in every direction around the primary ray. It has been shown that, by the appropriate selection of the distance between the crystal and the screen surface, a maximal separation of the diffraction reflexes is achieved.

A simple construction is achieved in that the detector is a CCD (charge-coupled device) detector.

For the adaptation of the assembly to the small surface of the detector, the section between detector surface and screen surface tapers in the direction of the detector surface in such a way that the screen surface is larger than the detector surface. By the use of tapering fibers, the screen surface is imaged faithfully but reduced in size on the detector surface.

A universal application possibility for the most widely varying forms of photon energy is achieved by the disposition on the screen surface of a layer for the conversion of X-rays into photons of other wavelengths.

The covering of almost the entire solid angle in one measuring operation is achieved by arranging two curved surfaces facing one another in such a way that the respective centers of the surfaces are located at the same point in space.

The essential advantages result in the application of the invention according to the method in crytallography.

The curved screen surface, by preference in the form of a spherical shell, offers enormous advantages:

1. Greatest expansion possible of the screen surface, which permits the imaging of more reflexes separated from each other.

2. The detection of as large as possible a solid angle.

3. A larger screen surface and a greater reduction in size of this surface on the detector without the disadvantage of a greater signal loss is achieved.

4. By means of an appropriate selection of the distance between the crystal and the screen surface, an equidistant imaging of associated reflexes is achieved.

5. By means of a suitable selection at the same time, a minimal distortion of the image is achieved in every direction around the primary ray.

In this connection, the advantages stated under Points 4 and 5 are possible only with a spherical shell.

In crystallography, everything is aimed at imaging as much as possible in the way of measuring data within as brief a period of time as possible.

This is to do with the duration of the imaging in general and with the eventual life of the crystal. A detector assembly or a method which magnifies both the solid angle as well as the separation of the reflexes is of very great value.

Further advantageous embodiments are characterized in the subclaims.

### BRIEF DESCRIPTION OF THE DRAWINGS

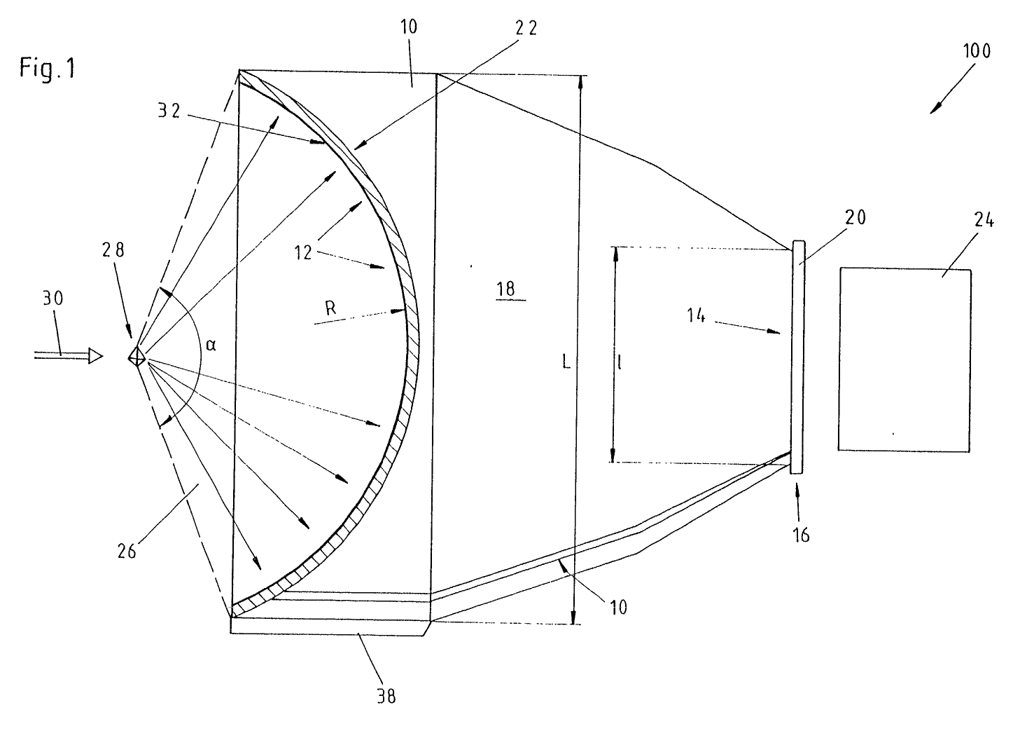

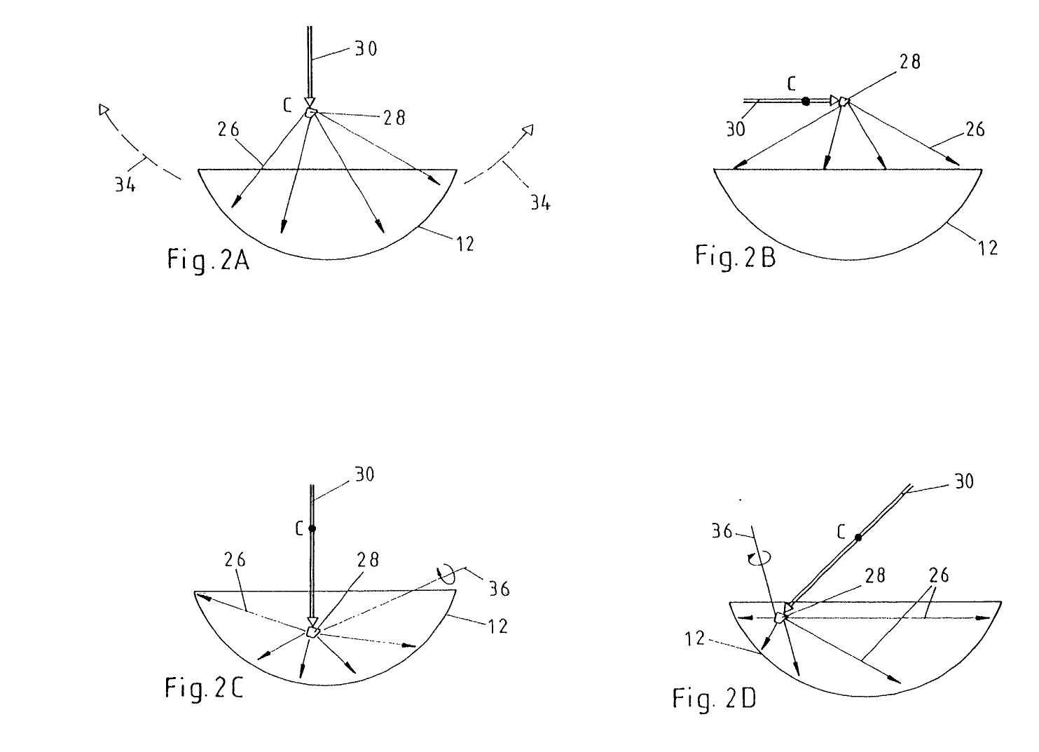

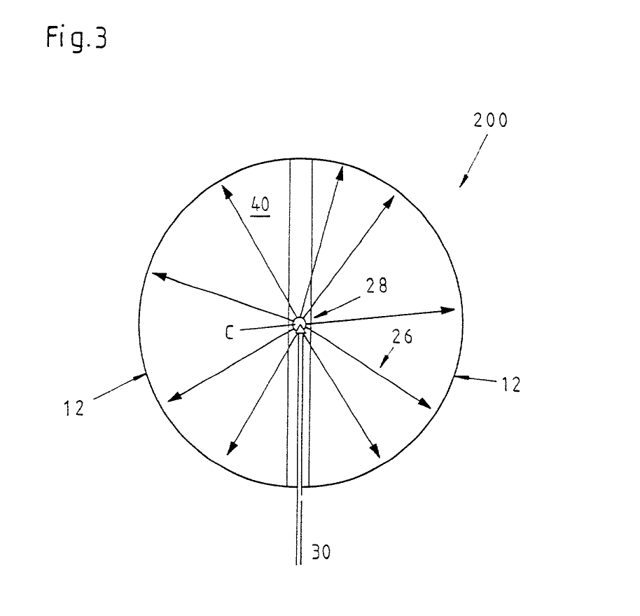

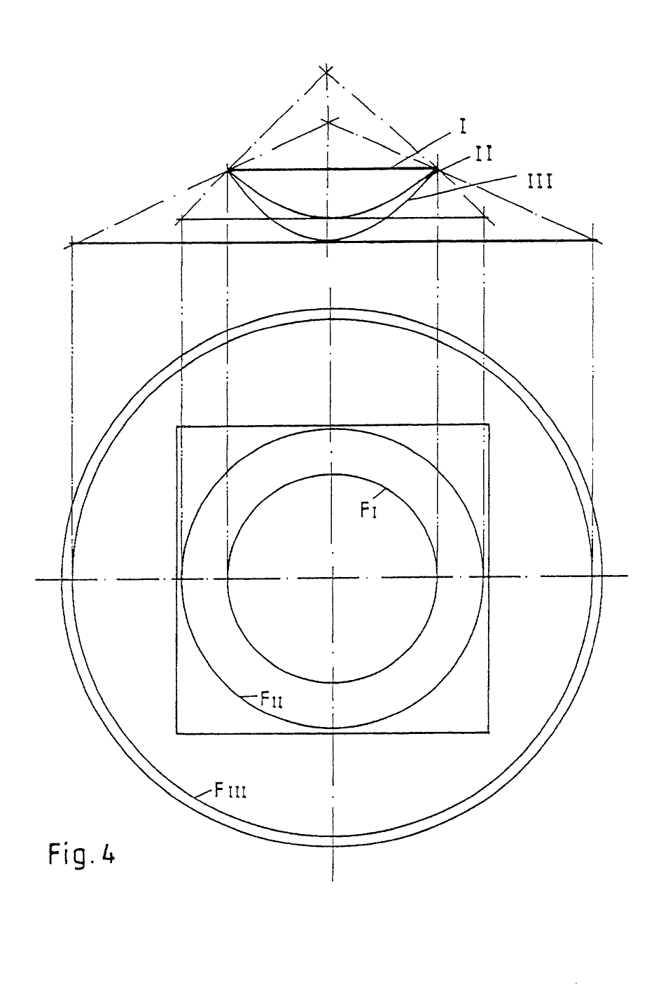

In the following the invention will be explained in greater detail with the aid of drawings. Thus, FIG. 1 shows a sectional view of a preferred embodiment of a detector assembly according to the invention; FIGS. 2A to 2D show different geometric arrangements of a detector assembly according to the invention for the imaging a X-ray diffraction patterns; FIG. 3 shows a sectional view of a further preferred embodiment of a detector assembly according to the invention; FIG. 4 shows in a schematic view the function of the detector assembly according to the invention.

### BEST WAY OF IMPLEMENTING THE INVENTION

FIG. 1 shows a sectional view of a preferred embodiment of a detector assembly 100 according to the invention. With this assembly 100, an object 28, by way of example a monocrystal, is analyzed in that a primary ray 30, e.g. an X-ray, strikes the object 28, is scattered by the object 28 and impinges in the form of scattered radiation 26 upon the input or screen surface 12.

The screen surface 12 is a curved surface and, in the depicted exemplary embodiment 100, possesses the configuration of a spherical shell, of which, in the sectional view in FIG. 1, a semicircle is visible. The spherical shell has the radius R. Furthermore, the screen surface 12 is provided with a layer of phosphorus 22. This layer 22 converts the X-ray diffraction radiation 26 into a wavelength or energy of the photons, which can be detected by a detector 16 described hereinafter.

In front of the phosphorus layer, also a layer or window 32 is disposed which is both actinically opaque as well as opaque to X-rays.

A fiber glass body 10 is adjacent to the layer of phosphorus 22. The same possesses first a straight section or light conductor section 38, which is followed by a narrowing section or light conductor section 18. This section 18 converts the image from the screen surface 12 into the size of the detector surface 14. A reduction in size takes place as it were. Disposed on the detector surface 14 is a photon detector 16, e.g. a CCD detector 20, which is read out by an electronic reading-out means 24. This thusly read-out diffraction image can then be used in a known manner for analyzing the object 28.

The angle alpha in FIG. 1 illustrates the maximal angular range of the scattered radiation which is covered by the screen surface 12. This angle is termed solid angle.

The parameters determining the imaging behaviour of the fiber glass body 10 are the radius R of the spherical area of the screen surface 12, the length L of the screen surface 12 and the length L of the detector surface 14.

Conventional fiber glass bodies have as screen surface a plane disk with the radius R. Consequently, its surface is πR². In contrast to the latter, the construction according to the invention has a surface area of the screen 12 of 2π², thus a surface are which is twice as large.

The scale of reduction in size is

m=L/l (1).

The length L of the semicircle is the arc length, viz.

L=2R/2=R (2)

The length L of a flat screen surface is

L=2R (3)

Consequently, with (1), for m with identical L and R for a flat screen surface 12

m=2R/l (4)

results and for the ehmispherical screen surface 12, an equivalent flat screen surface would amount to

m=πR/l (5).

In other words: By the geometry of the spherical area, the screen surface 12 possesses twice as large an area than a flat screen surface does, but a constant reduction in size m=2.

This becomes interesting when one examines the signal loss SV, which increases quadratically with m.

SV=m (6)

Consequently, for the hemispherical screen surface 12, in comparison with a corresponding flat screen surface, there results a signal gain of

[symbol]

SV=(3.14/2)²2.5 (7)

That is to say that the hemispherical screen surface 12, in relation to a flat screen surface of a corresponding length l, has a signal gain around the factor 2.5. This illustrates the great advantage of the assembly according to the invention relative to conventional assemblies. Practical values would forinstance be for a flat screen surface:

R=65 mm

L=2*65 mm=130 mm

l=49.15 mm

m=L/L=2.64,

which, with (1), (2) and (6) would amount to a signal weakening of 7.

For a hemispherical screen surface 12 with R=65 mm, thus corresponding to the external dimensions of the fiber glass body like above, for an equivalent flat screen surface there results:

Arc:

R=204 mm

l=49.15 mm

m=L/l=4.155,

which, with (1), (2) and (6) amounts to a signal diminution of 17. Consequently, the embodiment according to the invention has, in relation to a known system with equivalent dimensions, a signal gain of 17/7=2.4.

This signal gain is achieved by the projection of the spherical shell-like curved screen surface on to the flat plane of the detector. A narrowing of the image towards the image edge is produced thereby.

It can be mathematically proved that this apparent disadvantageous imaging can be advantageously utilized:

In the case of imaging X-ray diffraction patterns in the monocrystal structure determination, the reflexes to be measured expand immediately proportionally to the cosine of the scattering angle. It can be proved that, by the suitable selection of the distance, crystal to the screen surface of a spherical shell-shaped detector, the reflexes to be measured are equidistantly imaged. This fact is of great advantage when reflexes are separated and can only be achieved with a spherical shell-like configuration.

FIGS. 2A to 2D show different geometric arrangements between the object 28 to be analyzed and screen surface 12. In FIG. 2A, the object 28 is in the center of the spherical shell geometry of the screen surface 12. The primary ray 30 is radially incident. The detected scattered radiation 26 is forward scattering. As is indicated by arrows 34, the detector assembly is disposed so as to be swivellable about the center C.

When being swivelled about the center C, the goemetry as per FIG. 2B is possible. The object 28 still remains in the center C of the hemisphere geometry of the screen surface, but the primary ray 30 is tangentially incident now. The detected scattered radiation 26 is rearward scattering.

In FIG. 2C, the object 28 is disposed between the center C of the hemisphere geometry and the screen surface 12. The primary ray 30 is radially incident and forward scattering is measured. In this assembly the solid angle of the detected scattered radiation is greater than 180°.

A rotation of the detector assembly about the center C leads to the geometry of the FIG. 2D. The primary ray is incident approximately tangentially so that rearward scattering is measured. The solid angle of the detected scattered radiation 26 amounts to approximately 180°.

In the FIGS. 2C and 2D it is indicated with the aid of an axis 36 that the object to be analyzed is additionally rotatable about its own axis.

FIG. 3 shows a further preferred embodiment 200 of a detector assembly according to the invention. On this occasion two curved screen surfaces 12 are provided and disposed so as to face one another. In this case the two centers C and the screen surfaces 12 are located at the same point in space and, exactly at this point in space, the monocrystal 28 to be examined is located. The primary ray 30 is aligned between two detectors with exemplary spherically curved input area in such a manner that it penetrates into an almost spherical interior 40 of the assembly 200 and impinges upon the crystal 28 to be examined. The scattered radiation 26 is now imaged almost within the entire solid angle about the crystal 28 by the detector assembly 200 so that, with a single measuring operation, the entire sold angle of the diffracted X-rays 26 is covered.

The detector assembly according to the invention was exemplarily described for an assembly for the imaging of X-ray diffraction patterns, as is the case e.g. in the crystal structure analysis and in powder diffratometry. It is clear, however, that the invention is not restricted to this form of application. Thus the detector assembly according to the invention can, for example, be also employed for the detection of emitted photons, as e.g. gamma radiation. Such applications do by way of example exist in medicine where, with the aid of the isotope ¹³³Xe, regional cerebral blood flow systems, rCBF) are examined. Another area of application in medicine exists in CT scanners and in dental-medical applications, in which X-rays are used for fluoroscopy.

In FIG. 4 the function according to the invention of the assembly is illustrated. By means of a different configuration of the screen surface, i.e. with I flat, with II slightly curved and with III more strongly curved, it is possible to obtain correspondingly large equivalent surface detectors, FI (with flat detector), FII (with slightly curved detector) and FIII (with more strongly curved detector). That is why it is possible to obtain a solid angle by means of the curvature, which otherwise could only be achieved with a very large surface detector.

1. Detector assembly (100) for photons, more particularly X-ray gamma quanta, with a fiber glass body (10), which possesses a screen surface (12) for the imaging of photons, a detector surface (14) with a photon detector (16) mounted thereon, as well as an intermediate section (18) which conducts photons imaged by the screen surface (12) to the detector surface (14), characterized in that the screen surface (12) is configured as a curved surface.

2. Detector assembly according to claim 1,
characterized in that
the curved surface possesses the configuration of a spherical shell having the radius R.

3. Detector assembly according to claim 2,
characterized in that
the radius R possesses a value within the range of 50 to 140 mm, more especially 65 mm.

4. Detector assembly according to claim 1,
characterized in that
the curved surface possess the configuration of a cylindrical shell.

5. Detector assembly according to claim 1,
characterized in that
the curved surface possesses a parabolical configuration.

6. Detector assembly according to at least one of the preceding claims,
characterized in that
the detector (16) is a CCD detector (20) (charge-coupled device).

7. Detector assembly according to at least one of the preceding claims,
characterized in that
the section (18) between detector surface (14) and screen surface (12) tapers in the direction of the detector surface in such a fashion that the screen surface (12) is larger than the detector surface (14).

8. Detector assembly according to at least one of the preceding claims,
characterized in that,
on the screen surface (12), a layer (22) is disposed for the conversion of X-rays into photons of another wavelength.

9. Detector assembly according to claim 8,
characterized in that
the layer (22) is a phosphorus layer.

10. Detector assembly according to at least one of the preceding claims,
characterized in that
two curved surfaces are disposed facing towards each other in such a way that the respective centers of the surfaces are located at the same point in space.

11. Method for the crystal structure examination, more particularly monocrystal structure determination, with the aid of a detector assembly (100) for photons, especially X-ray gamma quanta, with a fiber glass body (10), which possesses a screen surface (12) for the imaging of photons, a detector surface (14) with a photon detector (16) mounted thereupon as well as an intermediate section (18), which conducts photons imaged by the screen surface (12) to the detector surface (14),
characterized in that
the screen surface (12) is configured in the form of a curved surface area.

12. Method according to claim 11,
characterized in that
by means of the use of the curved screen surface preferably configured in the form of a spherical shells the greatest expansion possible of the screen surface is provided, which permits the imaging of several reflexes separate from each other.

13. Method according to either claim 11 or 12,
characterized in that
the detection of of largest possible solid angle is performed.

14. Method according to any of claims 11 to 13,
characterized in that
a larger screen surface and a greater reduction in size of this surface on the detector is obtained without the disadvantage of a greater signal loss.

15. Method according to any of claims 11 to 14,
characterized in that
by means of an appropriate selection of the distance between the crystal and the screen surface, an equidistant image of associated reflexed is obtained.

16. Method according to any of claims 11 to 15,
characterized in that,
by means of an appropriate selection at the same time, a minimal distortion of the image is obtained, to be more precise, in all directions about the primary ray.

17. Application of a detector assembly (100) for photons, more particularly X-ray gamma quanta, with a fiber glass body (10), which possesses a screen surface (12) for the imaging of photons, a detector surface (14) with a photon detector mounted thereupon as well as an intermediate section (18) which conducts photons imaged by the screen surface to the detector surface (14), in which the screen surface (12) is configured in the form of a curved surface area.
